(19) United States
(12) Patent Application Publication
(10) Pub. No.: US 2013/0013830 A1
(43) Pub. Date: Jan. 10, 2013

(54) METHOD FOR MANAGING SUBNET IN COMPUTER SYSTEM, BUS ADAPTOR AND COMPUTER SYSTEM

(75) Inventors: Qun Jia, Shenzhen (CN); Baifeng Yu, Hangzhou (CN); Junfeng Zhao, Shenzhen (CN)

(73) Assignee: Huawei Technologies CO.,Ltd., Shenzhen (CN)

(21) Appl. No.: 13/543,531

(22) Filed: Jul. 6, 2012

Related U.S. Application Data
(63) Continuation of application No. PCT/CN2011/076983, filed on Jul. 8, 2011.

(51) Int. Cl. G06F 13/36

(52) U.S. Cl. 710/110; 710/306

(57) ABSTRACT

A method for managing a subnet in a computer system, comprising: providing a bus adaptor which is engaged with a notch of a PCIE bus in a computer system, wherein the computer system comprises a plurality of subnet nodes, each subnet node comprises a node control chip and at least one Central Processing Unit (CPU), each subnet node is connected to the PCIE bus, the PCIE bus connects the respective subnet nodes through an IB switchboard to construct a subnet; providing, by the bus adaptor, a network address of each subnet node; and performing communications between the subnet nodes according to the network address of each subnet node provided by the bus adaptor.

### CROSS-REFERENCE TO RELATED APPLICATIONS

This application is a continuation of International Application No. PCT/CN2011/076983, filed on Jul. 8, 2011, which are hereby incorporated by reference in their entireties.

### FIELD OF THE INVENTION

The embodiments of the present invention relate to the field of computer technology, and particularly, to a method for managing subnet through bus adapter in computer system, a bus adapter and a computer system.

### BACKGROUND OF THE INVENTION

The computer system includes servers such as minicomputer and mainframe. The methods for managing subnet in the computer system are described as follows by taking the minicomputer and the mainframe as examples.

With respect to the existing methods for managing subnet in the minicomputer, a minicomputer having 32 Central Processing Units (CPUs) is taken as an example to describe the method for managing a subnet in the minicomputer. The minicomputer includes 16 subnet nodes therein, each having a PCIE bus and a bridge jumper. The PCIE bus connects respective subnet nodes through an infiniband (IB) switchboard to construct a subnet, and each subnet node includes one Node Controller Chip (NCC) and two CPUs. One master subnet node and one standby master subnet node are selected from the 16 subnet nodes through competitions, and a node control chip on the master subnet node is responsible for the subnet management. The method for managing a subnet in the mainframe is the same as that for managing a subnet in the minicomputer, i.e., one master subnet node and one standby master subnet node are selected through node competitions, and a node control chip on the master subnet node is responsible for the subnet management.

However, in those methods for managing subnet, the bandwidth of the node control chip is occupied by the subnet management transactions, thus the overall service capabilities of various computer systems are impaired.

### SUMMARY

The embodiments of the present invention provide a method for managing subnet in computer system, a bus adapter and a computer system, which can release the bandwidth of the subnet node control chip in the computer system, so as to improve the overall performance of the computer system.

A method for managing a subnet in a computer system, comprising:

providing a bus adaptor which is engaged with a notch of a PCIE bus in a computer system, wherein the computer system comprises a plurality of subnet nodes, each subnet node comprises a node control chip and at least one Central Processing Unit (CPU), each subnet node is connected to the PCIE bus, the PCIE bus connects the respective subnet nodes through an IB switchboard to construct a subnet;

providing, by the bus adaptor, a network address of each subnet node; and

performing communications between the subnet nodes according to the network address of each subnet node provided by the bus adaptor.

A computer system, comprising: a PCIE bus, a bus adaptor, an IB switchboard and a plurality of subnet nodes, each subnet node has a node control chip and at least one Central Processing Unit (CPU), each subnet node is connected to the PCIE bus, the PCIE bus connects the respective subnet nodes through the IB switchboard to construct a subnet, and the bus adaptor is engaged with a notch of the PCIE bus;

the bus adaptor is configured to provide a network address of each subnet node;

each subnet node performs communications between the subnet nodes according to the network address of each subnet node provided by the bus adaptor.

A bus adaptor, the bus adaptor is engaged with a notch of a PCIE bus in a computer system, wherein the computer system comprises a plurality of subnet nodes, each subnet node comprises a node control chip and at least one Central Processing Unit (CPU), each subnet node is connected to the PCIE bus, the PCIE bus connects the respective subnet nodes through an IB switchboard to construct a subnet;

the bus adaptor is configured to provide a network address of each subnet node, so that each subnet node performs communications between the subnet nodes according to the network address of each subnet node provided by the bus adaptor.

According to the above technical solutions, the embodiments of the present invention have the following advantages:

In the embodiments of the present invention, the computer system is added with the bus adaptor that has the subnet management function, so as to manage the subnet by engaging the bus adaptor with the notch of the PCIE bus. As compared with the prior art where a plurality of subnet nodes in the computer system compete with each other so that the subnet is managed by the node control chip of the master subnet node that wins the competition, the method for managing a subnet in a computer system provided by the embodiments of the present invention manages the subnet through the bus adaptor, thereby releasing the bandwidth of the node control chip, and improving the overall performance of the computer system.

### BRIEF DESCRIPTION OF THE DRAWINGS

FIG. 1 is a schematic diagram of a method for managing a subnet according to an embodiment of the present invention;

FIG. 2 is a schematic diagram of another method for managing a subnet according to another embodiment of the present invention;

FIG. 3 is a schematic diagram of a computer system according to an embodiment of the present invention;

FIG. 4 is a schematic diagram of a computer system according to another embodiment of the present invention;

FIG. 5 is a schematic diagram of a bus adaptor according to an embodiment of the present invention; and

FIG. 6 is a schematic diagram of a bus adaptor according to another embodiment of the present invention.

### DETAILED DESCRIPTION OF THE PREFERRED EMBODIMENTS

The embodiments of the present invention provide a method for managing subnet in computer system, a bus adapter and a computer system. The embodiments of the present invention manage the subnet in the computer system through the bus adapter, release the bandwidth of the node control chip in the computer system, and improve the overall performance of the computer system.

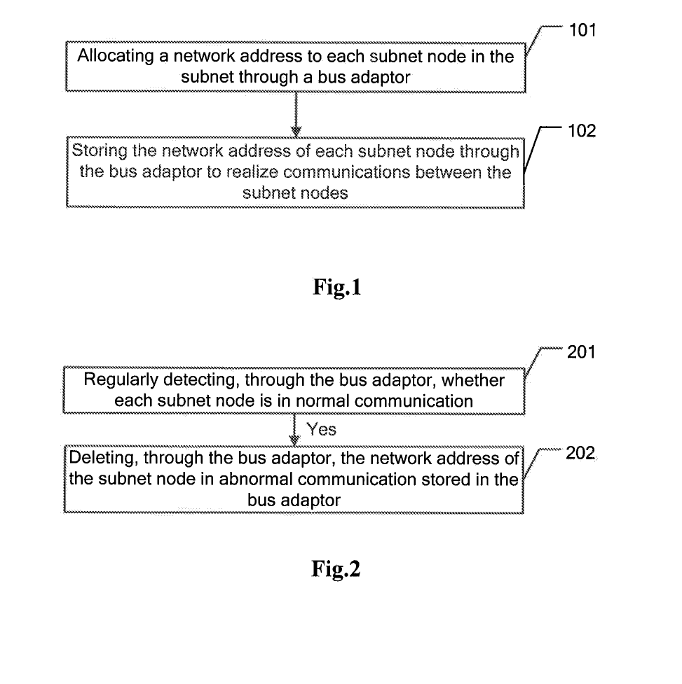

Referring to FIG. 1, the method for managing subnet in computer system according to an embodiment of the present invention includes:

101: allocating a network address to each subnet node in the subnet through a bus adaptor.

The computer system includes a plurality of subnet nodes each having a node control chip and at least one CPU. Each subnet node is connected through a bridge jumper to a PCIE bus that connects the respective subnet nodes through an IB switchboard to construct a subnet. The computer system further includes a master on-board management server and a slave on-board management server which are connected to the subnet via the PCIE bus. The bus adapter is engaged with the notch of the PCIE bus to allocate a network address to each subnet node in the subnet.

The bus adaptor detects the subnet nodes one by one, and when a subnet node is detected, allocates a network address to the detected subnet. The bus adaptor a locates different network addresses to the respective subnet nodes.

This embodiment may provide two bus adaptors, i.e., a master bus adaptor and a standby bus adaptor. The standby bus adaptor monitors the master bus adaptor, and in case the master bus adaptor is abnormal, the standby bus adaptor replaces it. The standby bus adaptor backs up the network addresses allocated to the respective subnet nodes by the master bus adaptor, so that the standby bus adaptor can immediately enter the working state once the master bus adaptor is abnormal.

The master bus adaptor and the standby bus adaptor may be engaged with the notches of the PCIE bus that connects the subnet nodes. Alternatively, the master bus adaptor is engaged with the notch of the PCIE bus of the master on-board management server, while the standby bus adaptor is engaged with the notch of the PCIE bus of the slave on-board management server.

102: storing the network address of each subnet node through the bus adaptor to realize communications between the subnet nodes.

After allocating the network addresses to the respective subnet nodes, the bus adaptor shall store the network address of each subnet node in the bus adaptor, the source node inquires of the bus adaptor about the network address of the target node when communications are carried out between the nodes.

In the embodiment of the present invention, the bus adaptor is engaged with the notch of the PCIE bus to manage the subnet. After allocating the network addresses to the respective subnet nodes, the bus adaptor stores the network address of each subnet node in the bus adaptor, communications between the nodes are carried out conveniently. By managing the subnet using the bus adaptor, the subnet nodes of the computer system no longer need to compete with each other, and the control chip on the subnet node is no longer required to manage the subnet transaction. Thus as compared with the prior art that manages the subnet transaction through the control chip on the master subnet node, this embodiment releases the bandwidth of the master subnet node, and improves the overall performance of the computer system.

The above embodiment is described through an example where there are two bus adaptors. In fact, there may be one bus adaptor engaged with the notch of the PCIE bus that connects the subnet nodes, or the notch of the PCIE bus of the master on-board management server. One bus adaptor can also perform the subnet management, only the stability being slightly poorer than the situation where there are two bus adaptors. In case such bus adaptor is failed, no substitutive bus adaptor is available, and the computer system has to be shut down for maintenance.

Referring to FIG. 2, alternatively on the basis of the first embodiment, another embodiment of the present invention further includes:

201: regularly detecting, through the bus adaptor, whether each subnet node is in normal communication, and performing step 202 when a subnet node in abnormal communication is detected.

202: deleting, through the bus adaptor, the network address of the subnet node in abnormal communication stored in the bus adaptor.

In case a subnet node in abnormal communication is detected, it means that the subnet node is failed or pulled out. By detecting the fault node and deleting the network address thereof through the bus adaptor, other subnet nodes can be prevented from continuing communicating with that subnet node, and communication confusions in the subnet are avoided.

In the embodiment of the present invention, when a subnet node in abnormal communication is detected, the network address thereof is deleted in time, so as to prevent other subnet nodes from continuing communicating with the abnormal subnet node, and avoid too many packets sent to the abnormal subnet node in the subnet from being not processed, thus communication confusions in the subnet will not be caused.

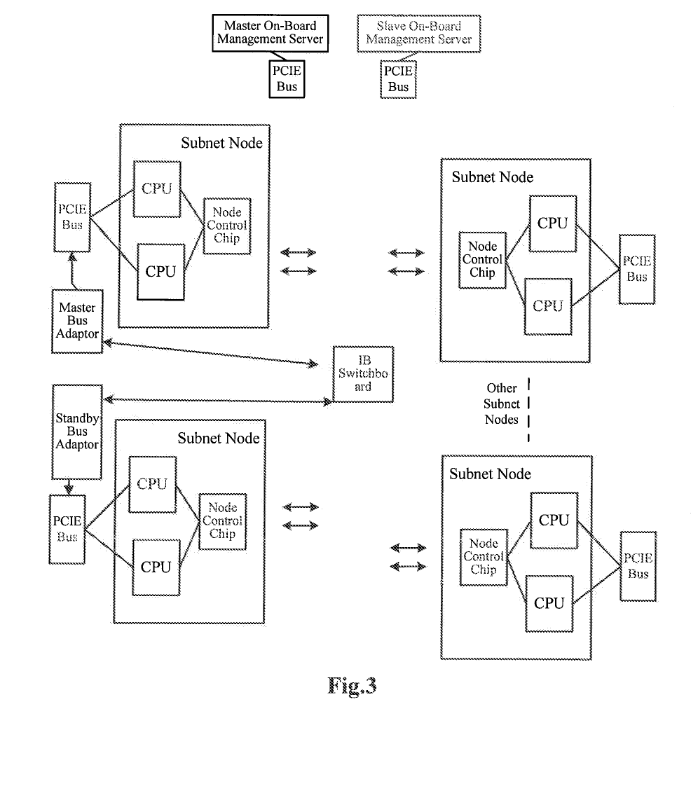

Referring to FIG. 3, the computer system according to an embodiment of the present invention is described as follows

The computer system includes a plurality of subnet nodes, each having a node control chip and two CPUs. Each subnet node is connected through a bridge jumper to a PCIE bus that connects the respective subnet nodes through an IB switchboard to construct a subnet, The computer system further includes a master on-board management server and a slave on-board management server which are connected to the subnet via the PCIE bus. The computer system further includes a master bus adaptor and a standby bus adaptor which are respectively engaged with the notches of the PCIE bus that connects the subnet nodes. In this embodiment, the master bus adaptor includes:

an address allocation unit, allocates a network address to each subnet node in the subnet;

a storage unit, stores the network address of each subnet node after the address allocation unit allocates the network address to each subnet node in the subnet, so as to realize communications between the subnet nodes;

a regular detection unit, regularly detects whether each subnet node is in normal communication; and

a deletion unit, deletes the network address of a subnet node in abnormal communication stored in the bus adaptor when the subnet node in abnormal communication is detected by the regular detection unit.

In this embodiment, the standby bus adaptor includes:

a monitoring unit, monitors the master bus adaptor and replace it with the standby bus adaptor when the master bus adaptor is abnormal; and

a backup unit, backs up the network address allocated to each subnet node by the master bus adaptor.

In practice, both the master bus adaptor and the standby bus adaptor include the above units, and the distinctions are made herein just based on different operations.

In the embodiment of the present invention, the two bus adaptors are respectively engaged with the notch of the PCIE bus that connects the subnet nodes, so as to manage the subnet. As compared with the prior art that manages the subnet of the computer system with the master subnet node selected through node competitions, this embodiment releases the bandwidths of the control chips of the master subnet node and the auxiliary subnet node, and improves the performance of the computer system.

Alternatively, the number of the bus adaptors is not limited to two, and there may be just one bus adaptor that performs the operations to be made by the master bus adaptor. Of course, there may be more than two bus adaptors, but corresponding software edition difficulty is increased once an adaptor is added. Therefore, it is suitable to employ two bus adaptors in the practical applications.

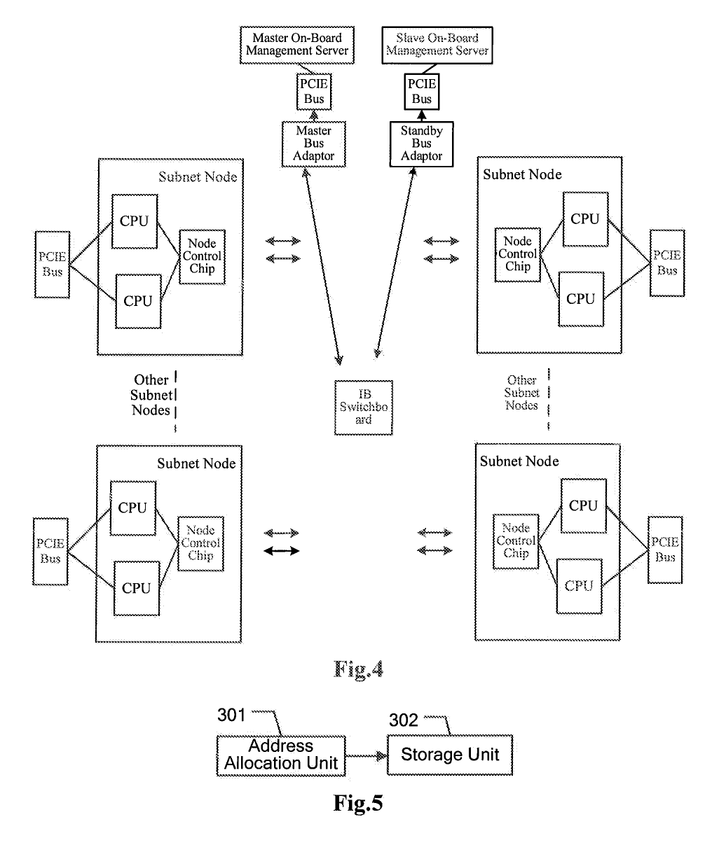

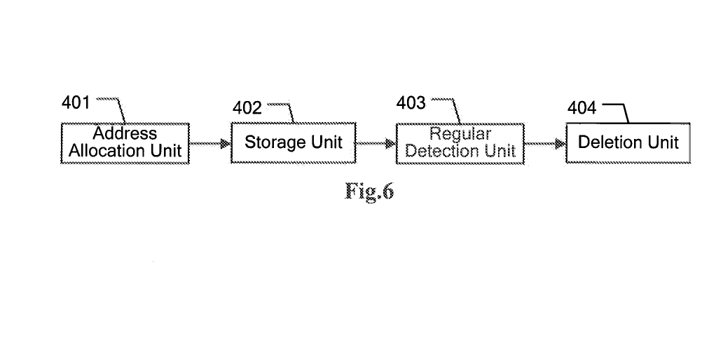

Referring to FIG. 4, the computer system according to another embodiment of the present invention is described as follows.

The computer system includes a plurality of subnet nodes, each having a node control chip and two CPUs. Each subnet node is connected through a bridge jumper to a PCIE bus that connects the respective subnet nodes through an IB switchboard to construct a subnet. The computer system further includes a master on-board management server and a slave on-board management server which are connected to the subnet via the PCIE bus. The computer system further includes a master bus adaptor engaged with the notch of the PCIE bus of the master on-board management server, and a standby bus adaptor engaged with the notch of the PCIE bus of the slave on-board management server. The functions of the master and standby bus adaptors are the same as those described in the above embodiments, and herein are omitted.

In the embodiment of the present invention, the two bus adaptors are respectively engaged with the notch of the PCIE bus of the master on-board management server and the notch of the PCIE bus of the slave on-board management server, so as to manage the subnet. As compared with the prior art that manages the subnet of the computer system with the master subnet node selected through node competitions, this embodiment releases the bandwidths of the control chips of the master subnet node and the auxiliary subnet node, and improves the performance of the computer system.

Alternatively, when there is only one bus adaptor, it is engaged with the notch of the PCIE bus of the master on-board management server, so as to perform the operations to be made by the master bus adaptor.

The bus adaptor of the present invention is introduced as follows. Referring to FIG. 5, the bus adaptor according to a first embodiment of the present invention includes an address allocation unit 301 and a storage unit 302.

The address allocation unit 301 allocates a network address to each subnet node in the subnet; and

the storage unit 302 stores the network address of each subnet node after the address allocation unit allocates the network address to each subnet node in the subnet, so as to realize communications between the subnet nodes.

In the embodiment of the present invention, after the address allocation unit 301 allocates the network address to each subnet node in the subnet, the storage unit 302 stores the network address of each subnet node, so as to realize communications between the subnet nodes. The bus adaptor provided by the embodiment of the present invention can manage the subnet in the computer system. As compared with the prior art that manages the subnet transaction through the control chip on the master subnet node, this embodiment releases the bandwidth of the master subnet node, and improves the overall performance of the computer system.

Referring to FIG. 4, based on the bus adaptor according to the above embodiment, the bus adaptor according to another embodiment of the present invention includes: an address allocation unit 401, a storage unit 402, a regular detection unit 403 and a deletion unit 404.

The address allocation unit 401 and the storage unit 402 are the same as those described in the above embodiment, and herein are omitted.

The regular detection unit 403 regularly detects whether each subnet node is in normal communication.

The deletion unit 404 deletes the network address of a subnet node in abnormal communication stored in the bus adaptor when the subnet node in abnormal communication is detected by the regular detection unit 403.

In the embodiment of the present invention, after the address allocation unit 401 allocates the network address to each subnet node in the subnet, the storage unit 402 stores the network address of each subnet node, the regular detection unit 403 regularly detects each subnet node, and the deletion unit 404 deletes the network address of a subnet node in abnormal communication stored in the storage unit 402 when the subnet node in abnormal communication is detected by the regular detection unit, so as to prevent other subnet nodes from continuing communicating with the abnormal subnet node, and avoid too many packets sent to the abnormal subnet node in the subnet from being not processed, thus communication confusions in the subnet will not be caused.

A person skilled in the art shall be appreciated that all or a part of steps for implementing the above method embodiments may be completed by instructing relevant hardware through a program that may be stored in a computer readable storage medium. The storage medium may be a ROM, a magnetic disk, an optical disk, etc.

The method for managing subnet in computer system, the bus adapter and the computer system provided by the present invention are detailedly described as above. According to the ideas of the embodiments of the present invention, a person skilled in the art can change the specific embodiments and the application scope. Therefore, the contents of Specification shall not be construed as limitations to the present invention.

What is claimed is:

1. A method for managing a subnet in a computer system, comprising:
providing a bus adaptor which is engaged with a notch of a PCIE bus in a computer system, wherein the computer system comprises a plurality of subnet nodes, each subnet node comprises a node control chip and at least one Central Processing Unit (CPU), each subnet node is connected to the PCIE bus, the PCIE bus connects the respective subnet nodes through an IB switchboard to construct a subnet;
providing, by the bus adaptor, a network address of each subnet node; and performing communications between the subnet nodes according to the network address of each subnet node provided by the bus adaptor.

2. The method for managing a subnet in a computer system according to claim 1, comprising:
detecting, through the bus adaptor, whether each subnet node is in normal communication;
deleting, through the bus adaptor, the network address of the subnet node in abnormal communication stored in the bus adaptor when a subnet node in abnormal communication is detected.

3. The method for managing a subnet in a computer system according to claim 1, wherein the bus adaptor is engaged with a notch of the PCIE bus that connects the subnet nodes.

4. The method for managing a subnet in a computer system according to claim 1, wherein the computer system further comprises a master on-board management server connected to the subnet via the PCIE bus, and the bus adapter is engaged with a notch of the PCIE bus of the master on-board management server.

5. The method for managing a subnet in a computer system according to claim 1, wherein the bus adaptor comprises a master bus adaptor and a standby bus adaptor;
Monitoring, through the standby bus adaptor, the master bus adaptor, and replacing the master bus adaptor with the standby bus adaptor when the master bus adaptor is abnormal;
backing up, through the standby bus adaptor, the network address allocated to each subnet node by the master bus adaptor.

6. The method for managing a subnet in a computer system according to claim 5, wherein the computer system further comprises a master on-board management server and a slave on-board management server which are connected to the subnet via the PCIE bus, the master bus adapter is engaged with a notch of the PCIE bus of the master on-board management server, and the standby bus adapter is engaged with a notch of the PCIE bus of the slave on-board management server.

7. A computer system, comprising: a PCIE bus, a bus adaptor, an IB switchboard and a plurality of subnet nodes, each subnet node has a node control chip and at least one Central Processing Unit (CPU), each subnet node is connected to the PCIE bus, the PCIE bus connects the respective subnet nodes through the IB switchboard to construct a subnet, and the bus adaptor is engaged with a notch of the PCIE bus;
the bus adaptor is configured to provide a network address of each subnet node;
each subnet node performs communications between the subnet nodes according to the network address of each subnet node provided by the bus adaptor.

8. The computer system according to claim 7, wherein the bus adaptor further comprising:
a detection unit configured to detect whether each subnet node is in normal communication; and
a deletion unit configured to delete the network address of a subnet node in abnormal communication stored in the bus adaptor when the subnet node in abnormal communication is detected by the regular detection unit.

9. The computer system according to claim 7, wherein the bus adaptor is engaged with a notch of the PCIE bus that connects the subnet nodes.

10. The computer system according to claim 7, wherein the computer system further comprises a master on-board management server connected to the subnet via the PCIE bus, and the bus adaptor is engaged with a notch of the PCIE bus of the master on-board management server.

11. The computer system according to claim 7, wherein the bus adaptor comprises a master bus adaptor and a standby bus adaptor,
the standby bus adaptor further comprising:
a monitoring unit configured to monitor the master bus adaptor, and replace the master bus adaptor with the standby bus adaptor when the master bus adaptor is abnormal; and
a backup unit configured to back up the network address allocated to each subnet node by the master bus adaptor.

12. The computer system according to claim 11, wherein the master bus adaptor and the standby bus adaptor are respectively engaged with the notches of the POE bus that connects the subnet node.

13. The computer system according to claim 11, further comprising a master on-board management server and a slave on-board management server which are connected to the subnet via the PCIE bus, the master bus adaptor is engaged with a notch of the PCIE bus of the master on-board management server, and the standby bus adaptor is engaged with a notch of the PCIE bus of the slave on-board management server.

14. A bus adaptor, the bus adaptor is engaged with a notch of a PCIE bus in a computer system, wherein the computer system comprises a plurality of subnet nodes, each subnet node comprises a node control chip and at least one Central Processing Unit (CPU), each subnet node is connected to the PCIE bus, the PCIE bus connects the respective subnet nodes through an IB switchboard to construct a subnet;
the bus adaptor is configured to provide a network address of each subnet node, so that each subnet node performs communications between the subnet nodes according to the network address of each subnet node provided by the bus adaptor.

15. The bus adaptor according to claim 14, further comprising
a detection unit configured to detect whether each subnet node is in normal communication; and
a deletion unit configured to delete the network address of a subnet node in abnormal communication stored in the bus adaptor when the subnet node in abnormal communication is detected by the regular detection unit.
